(19) United States
(12) Patent Application Publication
(10) Pub. No.: US 2026/0049478 A1
(43) Pub. Date: Feb. 19, 2026

(54) CLADDING ELEMENT FOR A WALL AND KIT COMPRISING AT LEAST ONE SUCH ELEMENT

(71) Applicant: ULTRAWATT, CEBAZAT (FR)

(72) Inventor: JEAN-CHARLES BATTUT, CHATEAUGAY (FR)

(21) Appl. No.: 19/217,516

(22) Filed: May 23, 2025

(30) Foreign Application Priority Data
Aug. 14, 2024 (FR) 2408936

(51) Int. Cl. E04F 13/08; A01G 9/02

(52) U.S. Cl. CPC E04F 13/0832; A01G 9/025; E04F 13/0871; E04F 2203/06; E04F 2290/00

(57) ABSTRACT

A cladding element (1) for a wall comprising a bottom (2) provided with four foldable edges (4 to 7), said bottom forming a parallelepiped when the edges (4 to 7) thereof are folded at right angles, a cover (8) provided with four foldable edges (11 to 14), said cover (8) forming a parallelepiped when the edges (11 to 14) thereof are folded at right angles, this cover (8) releasably blocking the opening of the parallelepiped formed by the bottom (2) and in that the assembly, bottom (2) and cover (8), is releasably inserted into the opening (16) of a parallelogram-shaped frame (15), two parallel edges (19, 20) of which are triangular in shape. The invention also relates to a kit comprising at least one such element (1).

The invention relates to a cladding element for a wall and to a kit comprising at least one such element. Herein, the term wall refers to a wall that is vertical or inclined with respect to the horizontal, or even completely horizontal, regardless of the type of this wall, whether concrete, breeze block, brick, wood, metal or any other material. Such a wall may be a structural external part like a wall or internal like a partition, of a building whether for domestic, commercial, industrial or other use. It can also be an insulated wall such as an enclosure wall, separation wall or other. Hereinafter, in order to facilitate reading, the invention will be more particularly disclosed in the case of a vertical external wall forming part of a structure such as a building. Such walls are frequently referred to by the term facade which will be used herein interchangeably with the term wall.

### DESCRIPTION OF THE RELATED ART

In the field of construction, devices are known that enable walls to be clad, in particular green walls. In addition to their aesthetic effect, these systems purify the air entering a building, keeping the ambient temperature around the wall less than the external temperature, and regulating the temperature of the building. These systems contribute to the biodiversity and insulation of buildings. FR-A-2 982 732 relates to a flexible net with pockets for receiving plants. EP-A-0708 208 discloses stacks of upward-opening containers receiving plants. WO-A-2017 146 628 relates to cassettes receiving plants and provided with perforated walls allowing air entering the building to be filtered through the plants when the air passes through the cassettes. IT-A-2021 0001 6973 discloses a frame-shaped wall-mounted container for soil and plants. The frame is attached to an inner wall and closed by a perforated cover. The system acts as a biological filter for an enclosed environment. Known systems are more or less complex to implement and can only be used to create fully green walls, in a non-modular manner. The invention offers a new solution for creating a green wall that is easy to install, modular and makes it possible to have a wall with more or less plants as required.

### BRIEF SUMMARY OF THE INVENTION

To this end, the object of the invention is a cladding element for a wall, comprising a bottom in the form of a planar and solid parallelogram provided with four foldable edges, said bottom forming a parallelepiped when the edges thereof are folded at right angles with respect to the main plane of the bottom, a cover in the form of a planar parallelogram provided with four foldable edges, said cover forming a parallelepiped when the edges thereof are folded at right angles with respect to the main plane of the cover, the latter releasably blocking the opening of the parallelepiped formed by the bottom, the assembly, formed by the bottom and the cover, being releasably inserted into the opening of a parallelogram-shaped frame, characterized in that two parallel edges of the frame are triangular in shape and in that the cover is, either at least in part, perforated, or the cover is equipped with a photovoltaic panel, a sound system or a light signal.

Thus, by virtue of the invention, we have a solution that makes it easy to create a cladding element for a wall by folding, offering a volume for receiving, for example plants, while at the same time being easy to attach and to detach from a wall by virtue of the attachment members.

According to advantageous but optional aspects of the invention, such an element may comprise one or more of the following features:

The triangular edges are each equipped with at least one member for releasably attaching the element to a wall.

The cover is totally solid.

A plant growing medium is inserted into the volume defined by the folded bottom and held in place by the cover.

A mulch is placed over the growing medium and under the cover and flush with the plane of the frame when the cover and the bottom are inserted into the frame.

The invention also relates to a kit comprising at least one cladding element, a growing medium for plants, mulch and plants, at least one other cladding element selected from cladding elements provided with a solid cover, from the cladding elements provided with a cover equipped with a photovoltaic panel, a sound system or a light signal.

The kit also comprises at least one supporting structure formed by at least two uprights and one cross member.

### BRIEF DESCRIPTION OF THE SEVERAL VIEW OF THE DRAWING

The invention will be better understood and other advantages thereof will become more clearly apparent on reading the following description, given solely by way of non-limiting example and with reference to the accompanying drawings, wherein:

FIG. 1 is an exploded top view of the various constituent parts of a cladding element conforming to one embodiment of the invention, before folding the edges and producing the element,

FIG. 2 is a perspective view from the face visible when the element is in place on a wall and on a larger scale, of the element shown in FIG. 1 once produced,

FIG. 3 is a perspective view and at the same scale, of the element shown in the figure from the rear non-visible face of the element,

FIG. 4 is a perspective view and at another scale, of a part of a wall equipped with cladding elements according to various embodiments, and

FIG. 5 is a partial side view and at a larger scale, of a member for attaching the element to a wall, according to one embodiment of the invention, prior to mounting on the wall.

### DETAILED DESCRIPTION OF THE INVENTION

FIG. 1 exemplifies the various constituent parts of a cladding element 1 conforming to one embodiment of the invention, prior to mounting the element 1. The various parts are produced from a lightweight, hard-wearing material that is impervious to weather conditions. For example, they are made of stainless steel or aluminum or another metal alloy. Alternatively, they can be made of a composite material or polymers. In the example exemplified in the various figures, element 1 has a rectangular shape. Alternatively it can be square shaped and/or of another dimension. In all cases, the element 1 is a parallelepiped when configured for use. The element 1 is formed of three independent parts that are releasably connected to each other.

The first part, on the right of FIG. 1, is the bottom 2, initially parallelogram-shaped, therefore rectangular herein. It is in pre-assembly configuration, namely the configuration that allows easy transport and storage as it occupies a minimum of space in this configuration. It comprises a main body 3, planar and solid. The body 3 defines a main plane P2 of the bottom 2. All the edges 4, 5, 6 and 7 of the body 3 can be folded at right angles with respect to plane P2. Thus, once the edges 4 to 7 have been folded, the bottom 2 is configured as a parallelepiped. It is conceivable that the width of the edges may differ from that exemplified in order to vary the height of the bottom 2, therefore its internal volume. The same applies to the dimensions of the bottom 2.

The second part is shown in the central section of FIG. 1. This is the cover 8. As with the bottom 2, the cover 8 is initially parallelogram-shaped, therefore rectangular herein. It is in pre-assembly configuration, namely the configuration that allows easy transport and storage as it occupies a minimum of space in this configuration. Herein, the main body 9 of the cover 8 is planar and perforated, with cut-outs 10 of complex shapes and variable dimensions being arranged. The body 9 defines a main plane P8 of the cover 8. All the edges 11, 12, 13 and 14 of the body 9 can be folded at right angles with respect to plane P8, similar to the edges 4 to 7 of the bottom 2. Thus, once the edges 11 to 14 are folded, the cover 8 is also configured as a parallelepiped. It is conceivable that the width of the edges may differ from that exemplified in order to vary the height of the cover 8, therefore its internal volume. The same applies to its dimensions.

The third part of the cladding element 1 is shown on the left-hand side of FIG. 1. This is a frame 15. This latter may be made of another material than the bottom 2 and/or the cover 8. The opening 16 in the frame 15 is shaped and sized to match that of the cover 8, so that it is flush and is coplanar with the main plane P15. Two edges 17, 18 are parallel, straight and of constant width. These edges 17, 18 are, like the edges 4 to 7 of the bottom 2 and the edges 11 to 14 of the cover 8, foldable at right angles, the frame 15 being, like the bottom 2 and the cover 8, initially flat and forming a planar element. Herein, the edges 17, 18 are those defining the width of the frame 15. Alternatively, it can be the edges defining the length of the frame 15, when this latter is rectangular.

The other two edges 19, 20 of the frame 15 are planar, identical and parallel, but with variable widths, regularly and along their entire lengths. In other words, they are configured as triangles according to their lengths. In another embodiment, the variability of the width of the edges 19, 20 is not regular along the length so that the edges are shaped like a double triangle, or even more. In all cases, the edges 19, 20 are also foldable at right angles and define at least inclined edges, presenting at least one angle depending on whether they are in the shape of a simple triangle or a complex triangle. The edges 19, 20 are each provided, on their free outer areas 21, respectively 22, with at least one attachment member 23. Herein, each edge comprises three identical members 23 evenly distributed along the length of each zone 21, 22. Alternatively, the number and/or the distribution of the attachment elements are different. Similarly, they may not all be identical.

In the embodiment of the invention exemplified in the various figures, the attachment members 23 are formed by an L-shaped cut-out, thus defining a solid hook-shaped part arranged in the outer zones 21, 22 of the edges 19, 20. Alternatively, the cut-outs can be elongated and undulated, then defining a variable-width groove for clipping. They can be of any other shape, more or less complex, bearing in mind that the members 23 must allow the frame 15 to be hooked and unhooked quickly, easily and repeatedly without affecting the mechanical and structural characteristics of the frame 15 and of the support on which the element 1 is mounted. Also, the shape chosen for the members 23 is the preferred, but not exclusive, shape, while being quick and easy to manufacture.

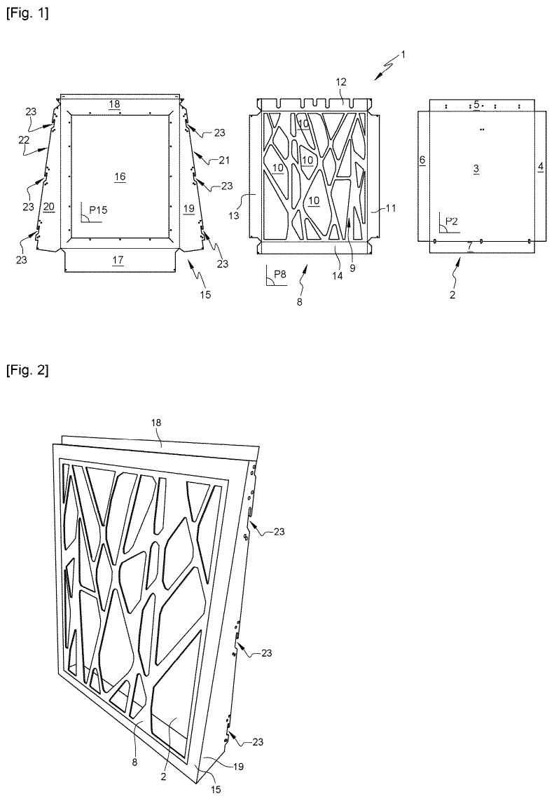

FIG. 2 exemplifies a cladding element 1 ready for installation. Herein, the cover 8 covers the bottom 2. The cover 8 is flush with the opening 16 of the frame 15 wherein it is positioned. Thus, the main planes P8 and P15 of the cover 8 and of the frame 15 merge. Note that the footprint of the element 1 corresponds to the footprint of the frame 15 when the edges 17 to 20 are folded, since the cover 8 and the bottom 2 are housed in the opening 16 of the frame 15.

FIG. 3 is similar to FIG. 2 and exemplifies the rear of the element 1. The edges 11 and 12 of the cover 8 are visible. Note that the assembly formed by the bottom 2 and the cover 8 are integrated into the volume formed by the folded edges 17 to 20 of the frame 15. In other words, the frame completely conceals the bottom 2 and the cover 8, with only the cut-out body 9 of the cover being visible from the front face of the frame 15. With such a configuration, it is easy to install the cladding element by virtue of the attachment elements 23 as long as the frame can be installed on a wall. The presence of a cable or a conduit referenced 24 emerging from the bottom 2 is noted. The conduit 24 may be an irrigation conduit, an electrical cable, an audio or video cable or any other sheath or conduit, depending on the nature of the cover 8 and/or the contents housed in the bottom 2. Alternatively, the number and/or the type of conduit may be different from that depicted.

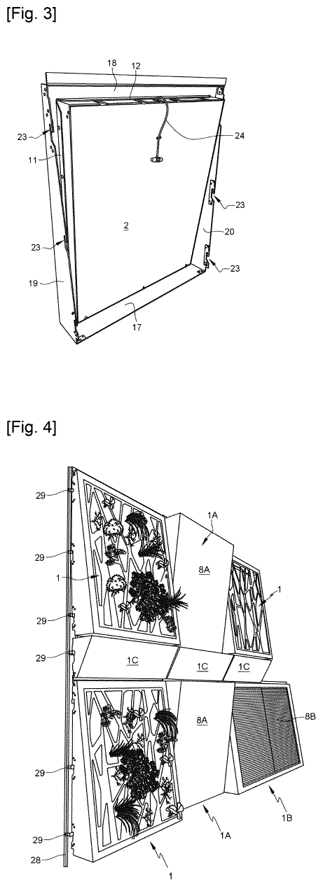

FIG. 4 exemplifies a part of a wall clad with several cladding elements 1. Some of the cladding elements correspond to elements 1 disclosed in FIGS. 1 to 3. As can be seen for the elements 1 located on the left of FIG. 4, these latter are used as plant growth containers. For this purpose, a growing medium, for example potting soil, sphagnum moss or other, is inserted into the volume defined by the bottom 2 once the edges 4 to 7 have been folded. The orifices 10 arranged in the cover 8 allow plants to grow on the exterior and to be seen. In one embodiment, to prevent any loss of the growing medium and to conserve the humidity thereof, a mulch is placed under the cover 8 and flush with the plane P15 of the frame 15 when the cover 8 and the bottom 2 are inserted into the frame 15. The plants pass through the mulch by virtue of holes. Such mulch can, for example, be plant-based, hair-based, synthetic foam-based or other.

The element 1 located on the right of FIG. 4 is empty, or at least no plants have yet grown. In this case, the cover 8, by virtue of the cut-outs 10, are purely aesthetic in function. In the central part of the wall part of FIG. 4, two elements 1A conforming to another embodiment of the invention are attached. Herein, the cover 8A of each element 1A is solid and flat. The elements 1A can accommodate a variety of components such as technical modules, sound systems or others. The appearance of each element 1A can be varied based on the smoothness and/or the color of the covers 8A. The element 1B, exemplified on the bottom right of FIG. 4, shows an element 1B whose cover 8B is equipped with a photovoltaic panel.

FIG. 4 also shows the presence of elements 1C, similar to elements 1A, but smaller in size. By virtue of the invention, as exemplified in FIG. 4, it is possible to clad a wall with elements 1, 1A, 1B, 1C having various aspects and/or dimensions, according to the user's wishes and in a modular manner, starting from so-called standard elements, it being understood that, for a same element 1, 1A, 1B, 1C, it is possible to obtain a different appearance by changing the cover 8, 8A, 8B and/or the nature of what the element 1, 1A, 1B, 1C contains, for example plants, light signaling equipment, sound equipment, energy production equipment or other.

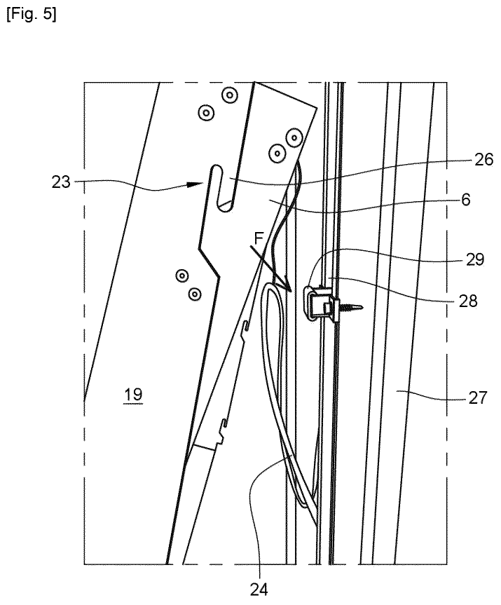

FIG. 5 exemplifies, on a larger scale, an attachment member 23, according to a preferred embodiment, in the pre-assembly position. This is the member 23 located on the top left of FIG. 3. A part of the folded edge 19 and of the edge 6 of the bottom 2 are visible, as is a portion of the sheath 24 which, in the illustration, is a drip irrigation sheath. The L-shaped configuration of the cut-out 25 in the member 23 makes it possible to define a solid lug 26 forming, with the cut-out 25, a hook for attaching the element 1 to a wall.

To perform the attachment, as shown in FIG. 5, the wall 27, for example a facade of a building, is equipped with a wire mesh comprising parallel and evenly-spaced vertical uprights 28 to which parallel and evenly-spaced cross members 29 are attached. The assembly thus defines a mesh attached to the wall. The means of fastening the uprights 29 and the cross members 29 to each other and to the wall 27 are known per se, for example by screws, rivets or other. As exemplified in FIG. 5, it is easy to attach the member 23 to a cross member 29 by the lug 26 thereof, according to arrow F. The number and/or the position of the uprights 28 and cross members 29 can be adapted on the one hand to the configuration of the wall 27, on the other hand, to the numbers and/or dimensions and/or configurations of the elements 1. By virtue of the invention, the cladding for a wall can be produced easily and easily modifiable, without affecting the wall, once the uprights 28 and cross members 29 are in place.

According to an advantageous embodiment, a cladding kit is provided. Such a kit comprises at least one supporting structure formed by at least two uprights 28 and a cross member 29, at least one cladding element formed by a bottom 2, a perforated cover 8 with cut-outs 10, a frame 15, a growing medium for plants, mulch and plants. In an advantageous variant, such a kit also comprises at least one other cladding element selected from the elements 1A with solid covers 8A, the elements 1B provided with a photovoltaic panel 8B or the elements 8C of dimensions other than the elements 1, 1A, 1B. Based on the number and the type of cladding elements in the kit and the number and type of uprights and cross members, it is possible to create different, modifiable claddings for a wall.

Advantageously such kits have dimensions suitable for being transported by container.

1. A cladding element (1, 1A, 1B, 1C) for a wall, comprising a bottom (2) in the form of a planar and solid parallelogram provided with four foldable edges (4, 5, 6, 7), said bottom (2) forming a parallelepiped when the edges (4, 5, 6, 7) thereof are folded at right angles with respect to the main plane (P2) of the bottom (2), a cover (8, 8A, 8B) in the form of a planar parallelogram provided with four foldable edges (11, 12, 13, 14), said cover (8, 8A, 8B) forming a parallelepiped when the edges (11, 12, 13, 14) thereof are folded at right angles with respect to the main plane (P8) of the cover (8), this latter releasably blocking the opening of the parallelepiped formed by the bottom (2), the assembly, formed by the bottom (2) and the cover (8, 8A, 8B), being releasably inserted into the opening (16) of a parallelogram-shaped frame (15), characterized in that two parallel edges (19, 20) of the frame (15) are triangular in shape and in that the cover (8) is, either at least in part, perforated (10), or the cover (8A, 8B) is equipped with a photovoltaic panel, a sound system or a light signal.

2. The element according to claim 1 wherein the triangular edges (19, 20) are each equipped with at least one member (23) for releasably attaching the element (1, 1A, 1B, 1C) to a wall (27).

3. The element according to claim 1 wherein the cover (8A, 8B) is totally solid.

4. The element according to claim 1 wherein a plant growing medium is inserted into the volume defined by the folded bottom (2) and held in place by the cover (8).

5. The element according to claim 4 wherein a mulch is placed over the growing medium and under the cover (8) and flush with the plane (P15) of the frame (15) when the cover (8) and the bottom (2) are inserted into the frame (15).

6. A kit comprising at least one cladding element according to claim 4, a growing medium for plants, mulch and plants, at least one other cladding element selected from cladding elements (1A, 1C) provided with a solid cover (8A), from cladding elements (1B) provided with a cover (8B) equipped with a photovoltaic panel, a sound system or a light signal.

7. The kit according to claim 6 wherein the kit also comprises at least one supporting structure formed by at least two uprights (28) and a cross member (29).
